(19) United States
(12) Patent Application Publication
(10) Pub. No.: US 2025/0322810 A1
(43) Pub. Date: Oct. 16, 2025

(54) Method of driving display panel and display driver circuit and gate driving circuit using the same

(71) Applicant: NOVATEK Microelectronics Corp., Hsin-Chu (TW)

(72) Inventor: Tso-Hua Chien, Hsinchu City (TW)

(73) Assignee: NOVATEK Microelectronics Corp., Hsin-Chu (TW)

(21) Appl. No.: 19/174,911

(22) Filed: Apr. 9, 2025

Related U.S. Application Data
(60) Provisional application No. 63/632,526, filed on Apr. 11, 2024.

(51) Int. Cl. G09G 3/36; G09G 3/3266

(52) U.S. Cl. CPC G09G 3/3677; G09G 3/3266; G09G 2310/0286; G09G 2310/08; G09G 2330/021; G09G 2340/0435

(57) ABSTRACT

A method of driving a display panel includes outputting a plurality of gate clock signals to the display panel, wherein the display panel includes a full refresh display area and a partial refresh display area. The plurality of gate clock signals are used by a gate driving circuit in the display panel, to generate a plurality of scan driving signals. In a partial refresh frame period, the plurality of gate clock signals keep toggling during N horizontal line periods corresponding to the full refresh display area and stop toggling during M horizontal line periods corresponding to the partial refresh display area.

### CROSS REFERENCE TO RELATED APPLICATIONS

This application claims the benefit of U.S. Provisional Application No. 63/632,526, filed on Apr. 11, 2024. The content of the application is incorporated herein by reference.

### BACKGROUND OF THE INVENTION

### 1. Field of the Invention

The present invention relates to a method of driving a display panel, and more particularly, to a method of driving a display panel with a multi-frequency driving technique.

### 2. Description of the Prior Art

Multi-frequency driving (MFD) is a novel display technique which generates images with different frame rates in different areas of the display panel. Under the MFD, an image frame may be divided into a full refresh display area and a partial refresh display area. For example, an area for displaying a video is preferably allocated to the full refresh display area, and another area showing text content is preferably allocated to the partial refresh display area. The MFD operations may save power consumption by reducing the refresh rate in the partial refresh display area, while keeping the refresh rate to achieve satisfactory image quality in the full refresh display area. The refresh rate allocation in each image frame may be performed dynamically to be adapted to the image content.

In the prior art, the MED operations performed on a liquid crystal display (LCD) panel could only divide an image frame into two different areas with different refresh rates, where the upper area must be the full refresh display area and the lower area must be the partial refresh display area. The refresh rate allocation for realizing the MFD control is not flexible.

### SUMMARY OF THE INVENTION

It is therefore an objective of the present invention to provide a method of driving a display panel with the multi-frequency driving (MFD) technique and related display driver circuit and gate driving circuit, in order to solve the abovementioned problems.

An embodiment of the present invention discloses a method of driving a display panel. The display panel comprises a full refresh display area and a partial refresh display area. The method comprises outputting a plurality of gate clock signals to the display panel, wherein the plurality of gate clock signals are used by a gate driving circuit in the display panel, to generate a plurality of scan driving signals. In a partial refresh frame period, the plurality of gate clock signals keep toggling during N horizontal line periods corresponding to the full refresh display area and stop toggling during M horizontal line periods corresponding to the partial refresh display area.

Another embodiment of the present invention discloses a display driver circuit for driving a display panel. The display panel comprises a full refresh display area and a partial refresh display area. The display driver circuit comprises a timing control circuit, which is configured to output a plurality of gate clock signals to the display panel, wherein the plurality of gate clock signals are used by a gate driving circuit in the display panel, to generate a plurality of scan driving signals. In a partial refresh frame period, the plurality of gate clock signals keep toggling during N horizontal line periods corresponding to the full refresh display area and stop toggling during M horizontal line periods corresponding to the partial refresh display area.

Another embodiment of the present invention discloses a gate driving circuit of a display panel. The display panel comprises a full refresh display area and a partial refresh display area. The gate driving circuit comprises a plurality of shift register circuits and a plurality of output enable circuits. The plurality of shift register circuits comprise a first shift register circuit and a second shift register circuit, wherein the first shift register circuit is configured to generate a first shift control signal which is utilized for generating a plurality of first scan driving signals driving scan lines in the full refresh display area, and the second shift register circuit is configured to generate a second shift control signal which is utilized for generating a plurality of second scan driving signals driving other scan lines in the partial refresh display area. The plurality of output enable circuits comprise a first output enable circuit and a second output enable circuit, wherein the first output enable circuit is configured to generate the plurality of first scan driving signals according to the first shift control signal and a plurality of gate clock signals, and the second output enable circuit is configured to generate the plurality of second scan driving signals according to the second shift control signal and the plurality of gate clock signals. The second output enable circuit stops outputting the second scan driving signal in response to the plurality of gate clock signals stopping toggling.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a display system according to an embodiment of the present invention.

FIG. 2 illustrates a detailed implementation of the GOA circuit according to an embodiment of the present invention.

FIG. 3 illustrates an exemplary image shown on a display panel.

FIG. 4 is a timing diagram of the GOA circuit in a full refresh frame period according to an embodiment of the present invention.

FIG. 5 is a schematic diagram of a display system according to an embodiment of the present invention.

FIG. 6 is a timing diagram of the GOA circuit in a partial refresh frame period according to an embodiment of the present invention.

FIG. 7 illustrates arrangements and combinations of the full refresh frame period and the partial refresh frame period to realize different frame rates.

FIGS. 8A-8C illustrate an exemplary implementation of realizing more different frame rates in different areas of the display panel.

FIG. 9 is a timing diagram of the GOA circuit in a partial refresh frame period with the reset signal.

### DETAILED DESCRIPTION

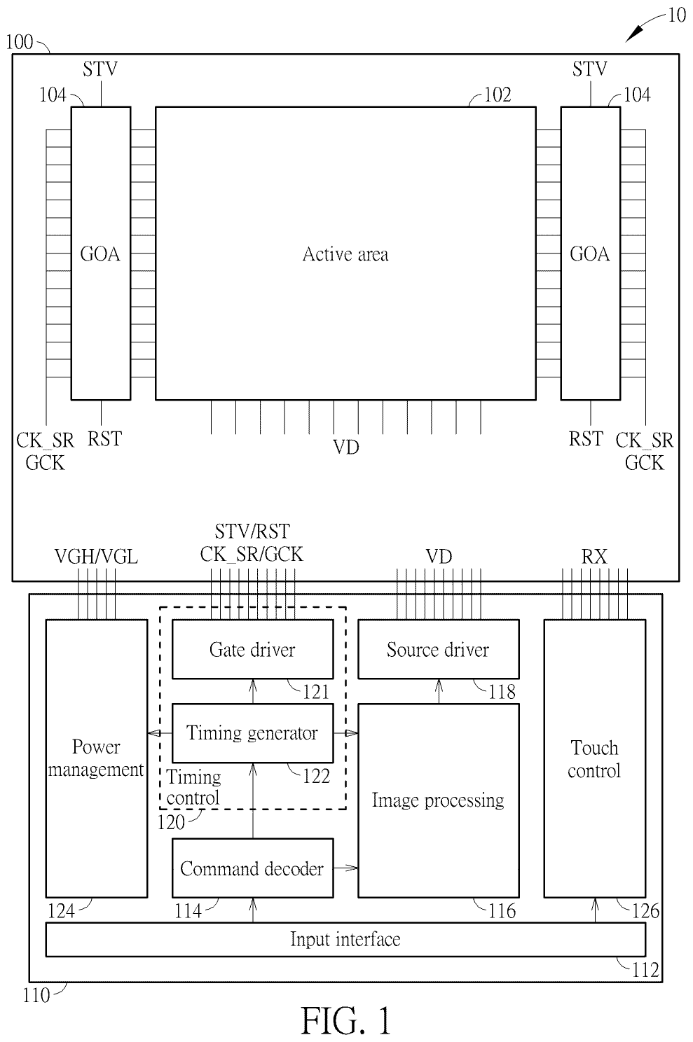

FIG. 1 is a schematic diagram of a display system 10 according to an embodiment of the present invention. The display system 10 includes a display panel 100 and a display driver circuit 110. The display panel 100 may be any type of display device, which may be, but not limited to, a liquid crystal display (LCD) panel. The display driver circuit 110 is configured to process display data and convert the display data into data voltages VD to be output to the display panel 100. The display driver circuit 110 may also control various operations of the display panel 100. In one or several embodiments, the display driver circuit 110 may be implemented as an integrated circuit (IC) included in a chip, as a display driver IC (DDIC).

The display panel 100 includes an active area 102 and at least one gate-on-array (GOA) circuit 104. The active area 102 is an area where a pixel array is deployed, where the images are shown on the active area 102 during the display operations. The GOA circuit 104 is usually deployed on the left and/or right side of the active area 102. The GOA circuit 104 may output multiple scan driving signals (also called gate driving signals) to the pixel array through multiple scan lines (also called gate lines), to control each pixel to be turned on with an appropriate timing to receive the corresponding data voltage VD. In general, the GOA circuit 104 may generate the scan driving signals by receiving control signals from the display driver circuit 110. These control signals may include a frame start pulse STV, a shift clock CK SR, one or more gate clock signals GCK, and/or a reset signal RST, but not limited herein.

The display driver circuit 110 may control the operations of the display panel 100 by outputting the data voltages VD and correspondingly outputting the control signals to the display panel 100. In detail, the display driver circuit 110 includes an input interface 112, a command decoder 114, an image processing circuit 116, a source driver 118, a timing control circuit 120, a power management module 124 and a touch control circuit 126.

The input interface 112 may couple the display driver circuit 110 to a front-end device such as a host processor (not illustrated). In general, the host processor may serve as a video source to provide raw display data for the display driver circuit 110, where the raw display data are sent to the display driver circuit 110 through the input interface 112 such as the mobile industry processor interface (MIPI). In one or several embodiments, the display driver circuit 110 may be coupled to a memory device through the input interface 112, and receive necessary data or information from the memory device through the input interface 112 such as the serial peripheral interface (SPI). For example, several compensation data (such as demura data) used for image compensation are received from the memory device through the input interface 112.

The command decoder 114 is coupled to the input interface 112, to decode (e.g., decompress) the input data (display data and/or compensation data) received through the input interface 112, to convert the input data into a form that could be recognized and processed by the image processing circuit 116.

The image processing circuit 116 may perform various image processing operations on the received raw display data, such as demura, deburn-in, or any other image processing or compensation process capable of improving the visual effects. After the image processing and/or compensation is completed, the image processing circuit 116 sends the compensated display data to the source driver 118.

The source driver 118 may convert the display data into data voltages VD to be sent to the pixels on the display panel 100. More specifically, the source driver 118 may include multiple source driving channels, where each channel is coupled to one or more data lines on the display panel 100, to send the data voltages VD to the corresponding data lines, which forward the data voltages VD to the target pixels.

In response to the transmissions of the data voltages VD through the data lines, the scan lines on the display panel 100 should be well controlled, to sequentially turn on the target pixels to receive the data voltages VD. As mentioned above, the scan driving signals forwarded through the scan lines are output by the GOA circuit 104 based on the control signals provided from the display driver circuit 110. Therefore, the timing control circuit 120 of the display driver circuit 110 may include a gate driver 121, which is configured to output the control signals, including the frame start pulse STV, the shift clock CK SR, the gate clock signals GCK, and/or the reset signal RST, to the GOA circuit 104.

In order to well control the output timing of the data voltages VD and related control signals, the timing control circuit 120 may further include a timing generator 122 for performing timing control. In various embodiments, the timing generator 122 may generate a vertical synchronization signal VS and a horizontal synchronization signal HS. The vertical synchronization signal VS is used to define the timing of a frame period where a frame of display data is received or output. The horizontal synchronization signal HS is used to define the timing of a horizontal line period where a line of display data is received or output.

The power management module 124 may supply power to each circuit block in the display driver circuit 110, and may also supply power to the display panel 100. In various embodiments, the power management module 124 may generate power supply voltages, which are used to determine a logic high voltage VGH and a logic low voltage VGL of the control signals for the GOA circuit 104, and provide the logic high voltage VGH and the logic low voltage VGL for the GOA circuit 104.

In one or several embodiments, the touch control circuit 126 may be integrated with the display driver circuit 110, to control the touch sensing operations of the display panel 100, where the display panel 100 is a touch panel. For example, as shown in FIG. 1, the touch control circuit 126 may receive touch sensing signals RX from the display panel 100, and then analyze the touch sensing signals RX to determine the touch position, so as to take measures in response to the touch behaviors. In another embodiment, if the display panel 100 is not a touch panel, the touch control circuit 126 may be disabled or omitted.

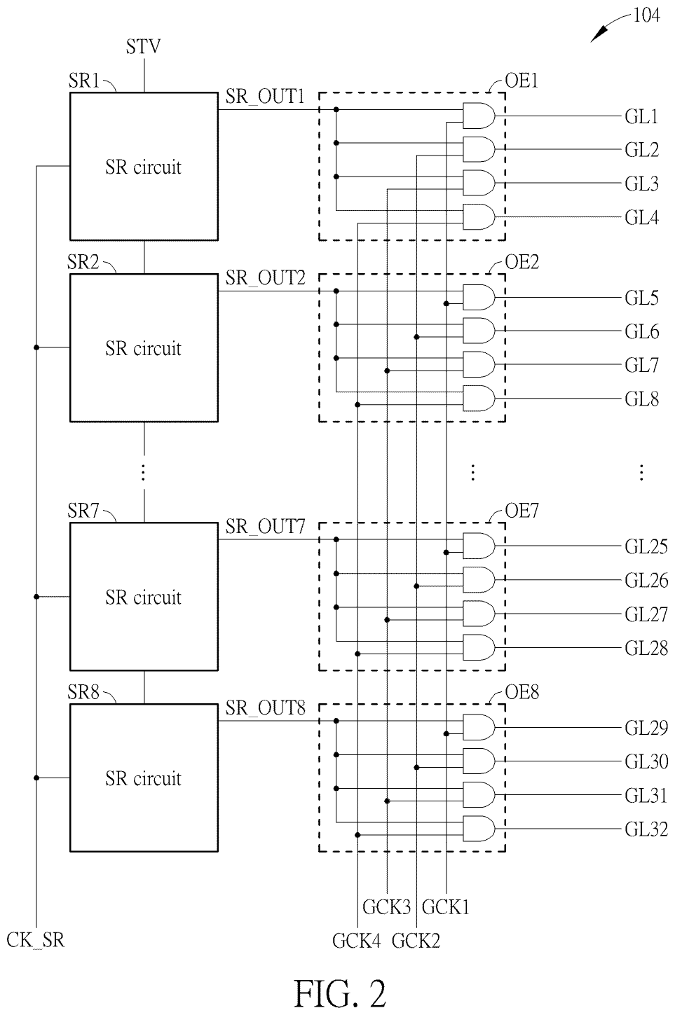

FIG. 2 illustrates a detailed implementation of the GOA circuit 104 according to an embodiment of the present invention. The GOA circuit 104 includes a plurality of shift register (SR) circuits SR1-SR8 and a plurality of output enable circuits OE1-OE8. The SR circuits SR1-SR8 are configured to generate a plurality of shift control signals SR_OUT1-SR_OUT8, respectively. More specifically, the SR circuits SR1-SR8 may receive the frame start pulse STV and the shift clock CK SR from the display driver circuit 110. The frame start pulse STV may control the shift control signals SR_OUT1-SR_OUT8 to start shifting and be output sequentially based on the timing determined by the shift clock CK SR.

In detail, the SR circuits SR1-SR8 may be connected in series. As for each SR circuit SR1-SR8, in response to receiving the frame start pulse STV or a shift control signal from the previous stage, the SR circuit SR1-SR8 may generate and output the corresponding shift control signal SR_OUT1-SR_OUT8 to the corresponding output enable circuit OE1-OE8, and may also output the shift control signal to trigger the SR circuit in the next stage.

The output enable circuits OE1-OE8 are configured to generate a plurality of scan driving signals GL1-GL32, respectively, according to the shift control signals SR_OUT1-SR_OUT8 by using a plurality of gate clock signals GCK1-GCK4, and output the scan driving signals GL1-GL32 to the active area 102 of the display panel 100 through respective scan lines. In this embodiment, the output enable circuits OE1-OE8 may sequentially output the scan driving signals GL1-GL32 by receiving the shift control signals SR_OUT1-SR_OUT8 based on the control of the gate clock signals GCK1-GCK4, where each output enable circuit may output four of the scan driving signals GL1-GL32 by receiving one of the shift control signals SR_OUT1-SR_OUT8. The gate clock signals GCK1-GCK4, which may be an implementation of the gate clock signal GCK shown in FIG. 1, are output to each of the output enable circuits OE1-OE8, to control the output timing of the scan driving signals GL1-GL32, in order to scan the pixel array of the display panel 100 in an appropriate sequence and timing.

In one or several embodiments, each of the output enable circuits OE1-OE8 is composed of multiple logic gates, to perform logic operations on the corresponding shift control signal SR_OUT1-SR_OUT8 and the gate clock signals GCK1-GCK4. For example, as shown in FIG. 2, each output enable circuit OE1-OE8 includes four “AND” gates, each receiving a corresponding shift control signal SR_OUT1-SR_OUT8 from the corresponding SR circuit SR1-SR8 and receiving a corresponding gate clock signal GCK1-GCK4. By performing logic operations on the received signals through the “AND” gates, each output enable circuit OE1-OE8 may generate and output the corresponding scan driving signals GL1-GL32.

Note that FIG. 2 only shows an exemplary embodiment where the GOA circuit 104 includes 8 channels and each channel is composed of one SR circuit and one output enable circuit. The circuitry in the 8 channels is configured to drive 32 scan lines by receiving 4 gate clock signals GCK1-GCK4. The implementations of the present invention are not limited herein. In another embodiment, there may be any number of SR circuits and output enable circuits included in a GOA circuit, and the number may be determined based on the size and/or resolution of the display panel. The GOA circuit may also receive any number of gate clock signals from the display driver circuit, where the number is not limited to those described in this disclosure. In a practical embodiment, there may be hundreds or thousands of scan lines on the display panel, and the GOA circuit may include at least hundreds of SR circuits and output enable circuits, where each output enable circuit may be configured to drive 4, 8, or any number of scan lines based on the number of gate clock signals.

The present invention is applied to realize the multi-frequency driving (MFD), where the images in different areas of the display panel are displayed with different frame rates. As for an area requested to perform high-frequency display, the pixels in this area may be refreshed in a high frequency, such as refreshed in every frame period; hence, the high-frequency refresh area is named a full refresh display area hereinafter. As for an area requested to perform low-frequency display, the pixels in this area may be refreshed in a low frequency, such as refreshed once in every 2 or 4 frame periods; hence, the low-frequency refresh area is named a partial refresh display area hereinafter. In each frame period, the pixel rows of the display panel are scanned in a predetermined sequence to be refreshed using corresponding display data or not. Note that the full refresh display area and the partial refresh display area described in this disclosure are not used to limit the actual frame rate of each display area. As long as the frame rate of the partial refresh display area is lower than the frame rate of the full refresh display area, which is achieved by refreshing or updating the pixel data in the partial refresh display area in fewer frame periods, the related implementations should belong to the scope of the present invention.

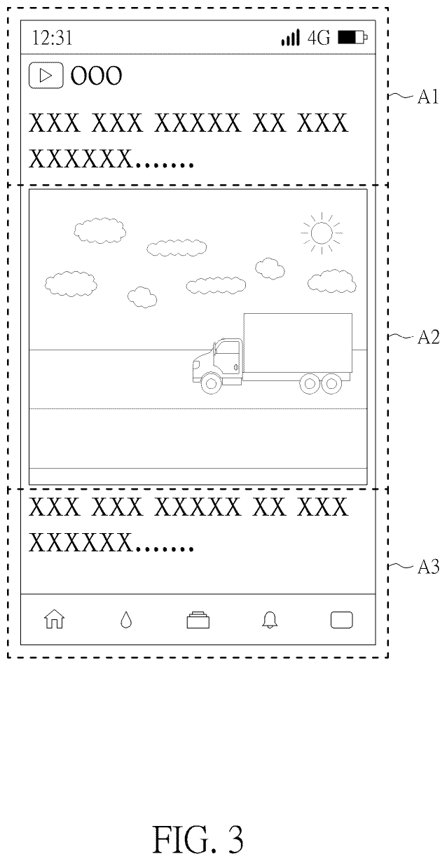

FIG. 3 illustrates an exemplary image shown on a display panel, which is a screen of a mobile phone. The display panel is divided into 3 areas A1-A3, where the areas A1 and A3 are partial refresh display areas and the area A2 is a full refresh display area. Referring to FIG. 3 along with FIG. 2, in order to flexibly allocate the full refresh display area and the partial refresh display area, the shift clock CK SR used for the SR circuits SR1-SR8 and the gate clock signals GCK1-GCK4 used for the output enable circuits OE1-OE8 may be controlled separately. In one or several embodiments, the shift clock CK SR and the frame start pulse STV are output to the GOA circuit 104 normally, while the gate clock signals GCK1-GCK4 are output based on the allocations of the full refresh display area and the partial refresh display area. With the control of the shift clock CK SR and the frame start pulse STV, the SR circuits SR1-SR8 may operate normally to generate the shift control signals SR_OUT1-SR_OUT8 in a predetermined timing; that is, the shift control signals SR_OUT1-SR_OUT8 are output sequentially regardless of whether the scan operation proceeds to the full refresh display area or the partial refresh display area. The output of the scan driving signals GL1-GL32 may be enabled or disabled by the output enable circuits OE1-OE8 based on the control of the gate clock signals GCK1-GCK4. In such a situation, the display driver circuit 110 may control the display panel 100 to perform refresh only in the full refresh display area by controlling the enable time of the gate clock signals GCK1-GCK4 (e.g., by determining the time points of starting the output of the gate clock signals GCK1-GCK4 and stopping the output of the gate clock signals GCK1-GCK4). Through appropriate settings of the gate clock signals GCK1-GCK4, each pixel row may be selectively allocated to the full refresh display area or the partial refresh display area in a frame period, thereby realizing flexible frame rate allocations.

In such a situation, the display driver circuit 110 may start to toggle the gate clock signals GCK1-GCK4 at any time and stop toggling the gate clock signals GCK1-GCK4 at any time, so as to control each pixel row to be refreshed or not. As a result, the full refresh display area(s) and the partial refresh display area(s) may be flexibly allocated to any position of the display panel 100. For example, as shown in FIG. 3, the full refresh display area A2 may start at the top of the video area and end at the bottom of the video area. If the video area changes in another frame period, the range of the full refresh display area A2 may be adjusted accordingly. In another embodiment, there may be any number of full refresh display area(s) and any number of partial refresh display area(s) based on the image content, and these areas may be flexibly allocated to any position.

As mentioned above, the images in the full refresh display area may be refreshed in every frame period and the images in the partial refresh display area may be refreshed in one of multiple frame periods. In such a situation, there may be several frame periods in which all areas in the display panel are refreshed, and there may be several frame periods in which only the full refresh display area (or including one or some partial refresh display areas, not all) is refreshed. In the following embodiments, a frame period in which all areas (including the full refresh display area(s) and all of the partial refresh display area(s)) are refreshed is named a full refresh frame period, and a frame period in which not all areas are refreshed is named a partial refresh frame period.

In an embodiment, a full refresh display area may contain N horizontal line periods and a partial refresh display area may contain M horizontal line periods, where M and N may be any positive integer smaller than the number of the total pixel rows of the display panel, and M may be the same as or different from N. During the full refresh frame period, each of the gate clock signals may keep toggling when the scan operation proceeds through the N horizontal line periods corresponding to the full refresh display area and the M horizontal line periods corresponding to the partial refresh display area. In such a situation, the pixel rows in the full refresh display area and the partial refresh display area are all refreshed.

During the partial refresh frame period, each of the gate clock signals may keep toggling when the scan operation proceeds to the N horizontal line periods corresponding to the full refresh display area, but stop toggling when the scan operation proceeds to the M horizontal line periods corresponding to the partial refresh display area. In such a situation, the pixel rows in the full refresh display area are refreshed, while the pixel rows in the partial refresh display area are not refreshed, so as to realize the MFD control.

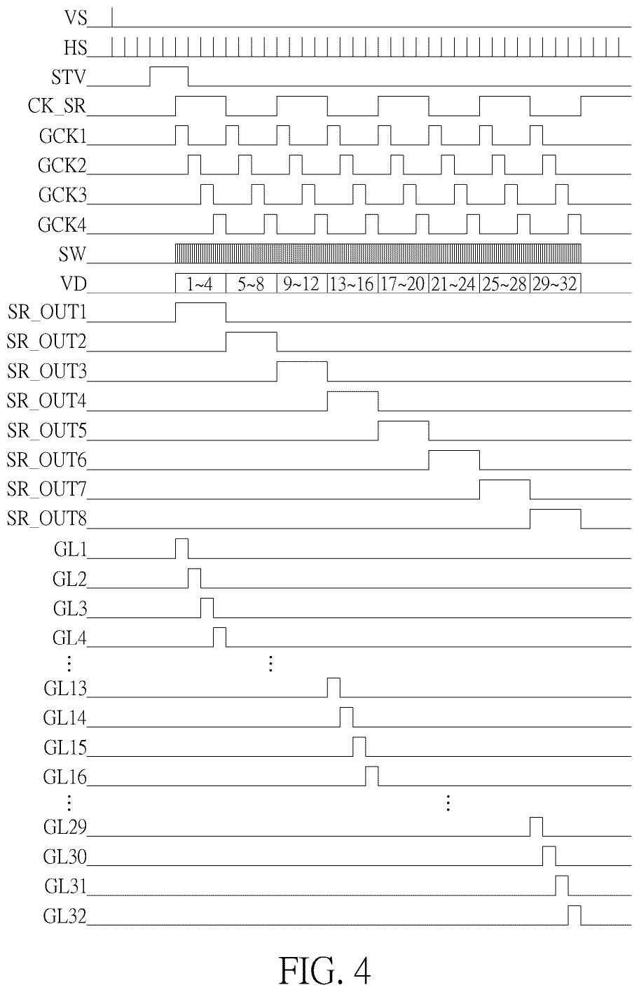

FIG. 4 is a timing diagram of the GOA circuit 104 in a full refresh frame period according to an embodiment of the present invention. The GOA circuit 104 may have a structure as shown in FIG. 2, and FIG. 4 shows the control signals output to the GOA circuit 104 from the display driver circuit 110, including the frame start pulse STV, the shift clock CK SR and the gate clock signals GCK1-GCK4. FIG. 4 also shows the shift control signals SR_OUT1-SR_OUT8 and the scan driving signals GL1-GL32 generated by the GOA circuit 104, and shows the data voltages VD and corresponding switching signals SW for the data lines. In order to facilitate the illustrations, FIG. 4 further shows the vertical synchronization signal VS and the horizontal synchronization signal HS, which are used by the display driver circuit 110 for determining the timing of these control signals.

Referring to FIG. 4 along with FIG. 2, in the full refresh frame period defined by a pulse of the vertical synchronization signal VS, the display driver circuit 110 outputs the frame start pulse STV and starts to toggle the shift clock CK SR used for the SR circuits SR1-SR8 of the GOA circuit 104. According to the frame start pulse STV and the shift clock CK SR, the SR circuits SR1-SR8 generate and output the shift control signals SR_OUT1-SR_OUT8 respectively and sequentially. At the time when each of the shift control signals SR_OUT1-SR_OUT8 is output, the display driver circuit 110 sequentially outputs the gate clock signals GCK1-GCK4 to the output enable circuits OE1-OE8 of the GOA circuit 104. Therefore, according to the shift control signals SR_OUT1-SR_OUT8 and the gate clock signals GCK1-GCK4, the output enable circuits OE1-OE8 sequentially output the scan driving signals GL1-GL32 to the corresponding scan lines on the display panel 100.

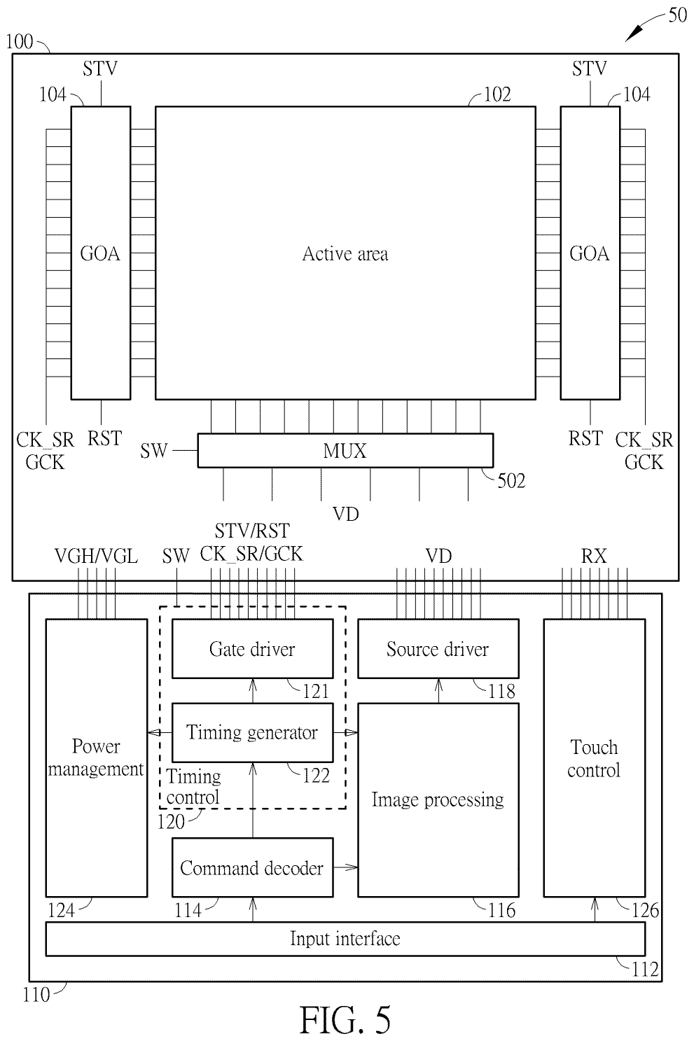

At this time, the display driver circuit 110 outputs the data voltages VD to the data lines on the display panel 100, and correspondingly outputs the switching signals SW to a multiplexer (MUX) circuit on the display panel 100. FIG. 5 is a schematic diagram of a display system 50 according to an embodiment of the present invention. The structure of the display system 50 is similar to the structure of the display system 10, so signals and elements having similar functions are denoted by the same symbols. The difference between the display system 50 and the display system 10 is that the display system 50 further includes a MUX circuit 502. The MUX circuit 502, which may be deployed on the display panel 100, is coupled between the active area 102 and the display driver circuit 110. More specifically, the MUX circuit 502 is coupled between multiple source driving channels in the source driver 118 of the display driver circuit 110 and multiple data lines on the display panel 100. The MUX circuit 502 may include multiple MUXs, each coupled between a source driving channel and multiple data lines. Each of the MUXs is controlled by a plurality of switching signals SW. The switching signals SW are used to electrically connect the corresponding source driving channel and one of the data lines in a time-divisional manner, to selectively forward the data voltages VD to the target data lines and corresponding pixels. In such a situation, the data voltages VD received by a MUX may be forwarded to different data lines through the control of the switching signals SW.

Therefore, during the refreshing operation, the display driver circuit 110 may output the data voltages VD to the MUX circuit 502 through the source driving channels. The display driver circuit 110 may also send the switching signals SW to the MUX circuit 502, e.g., through the timing control circuit 120. The MUX circuit 502 thereby forwards the data voltages VD to the target data lines according to the switching signals SW.

As shown in FIG. 4, there may be 32 scan lines on the display panel 100 controlled by the GOA circuit 104. In the full refresh frame period, the GOA circuit 104 may sequentially output the 32 scan driving signals GL1-GL32 to respective scan lines. This is achieved by outputting the gate clock signals GCK1-GCK4 by the display driver circuit 110 with the shifting of the pulse in the shift control signals SR_OUT1-SR_OUT8. If the display panel 100 enters a partial refresh frame period, the display driver circuit 110 is able to control when to output several control signals or not to the GOA circuit 104 to stop data refresh in the partial refresh display area.

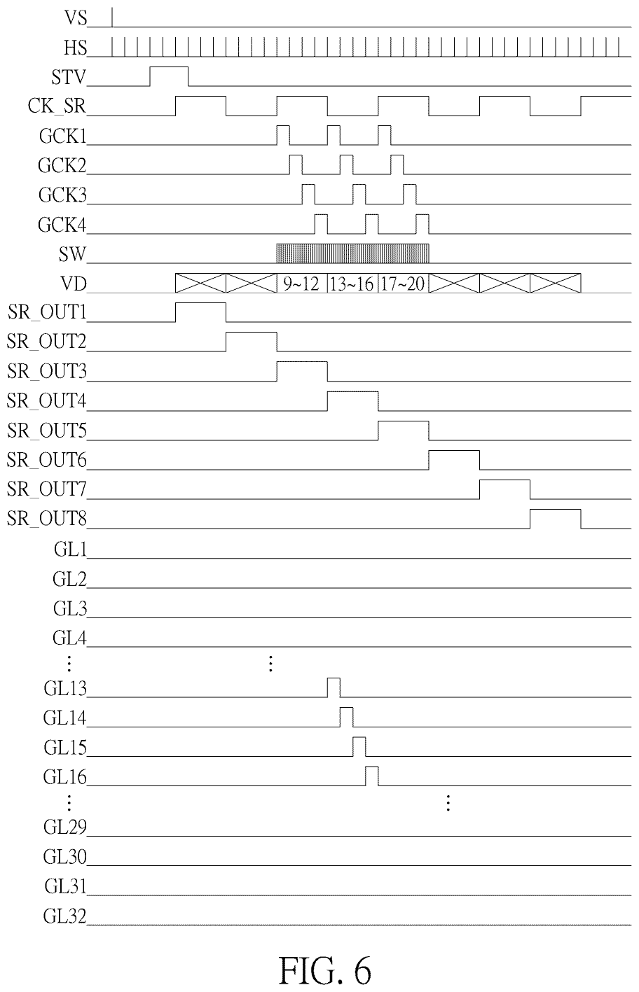

FIG. 6 is a timing diagram of the GOA circuit 104 in a partial refresh frame period according to an embodiment of the present invention. In this embodiment, the display panel 100 is configured to have an upper partial refresh display area from the 1^{st} to the 8^{th} scan lines, a full refresh display area from the 9^{th} to the 20^{th} scan lines, and a lower partial refresh display area from the 21^{st} to the 32^{nd} scan lines. These three areas may correspond to the areas A1-A3 shown in FIG. 3. In order to keep the scan operations during the partial refresh frame period, the frame start pulse STV and the shift clock CK SR are output normally as in the full refresh frame period, and thus the SR circuits SR1-SR8 operate normally to output the shift control signals SR_OUT1-SR_OUT8 sequentially.

More specifically, there may be one or more SR circuits (i.e., SR3-SR5) corresponding to the scan lines in the full refresh display area, and one or more SR circuits (i.e., SR1, SR2 and SR6-SR8) corresponding to the scan lines in the partial refresh display area. The SR circuits SR1-SR8, including those SR circuits for the full refresh display area and those SR circuits for the partial refresh display area, will always operate normally in both the full refresh frame period and the partial refresh frame period, to output the shift control signals SR_OUT1-SR_OUT8 sequentially.

Under normal operations of the SR circuits SR1-SR8 and the shift control signals SR_OUT1-SR_OUT8, the output of the scan driving signals GL1-GL32 for realizing the full refresh display area and the partial refresh display area may be controlled by the output enable circuits OE1-OE8 according to the gate clock signals GCK1-GCK4. In detail, in the partial refresh frame period shown in FIG. 6, during the 1^{st} to the 8^{th} horizontal line periods corresponding to the 1^{st} to the 8^{th} scan lines in the partial refresh display area A1, the gate clock signals GCK1-GCK4 stop toggling. At this time, the corresponding output enable circuits OE1 and OE2 stop outputting the scan driving signals GL1-GL8 in response to the stopped toggling of the gate clock signals GCK1-GCK4, to stop the refresh in the partial refresh display area A1.

Subsequently, during the 9^{th} to the 20^{th} horizontal line periods corresponding to the 9^{th} to the 20^{th} scan lines in the full refresh display area A2, the gate clock signals GCK1-GCK4 restart to toggle and keep toggling. At this time, the corresponding output enable circuits OE3-OE5 output the scan driving signals GL9-GL20 in response to the toggling of the gate clock signals GCK1-GCK4, to restart the refresh in the full refresh display area A2. Since the shift control signals SR_OUT3-SR_OUT5 corresponding to the full refresh display area A2 are output at the predetermined timing through the normal operations of the SR circuits, the scan driving signals GL9-GL20 may be successfully output when the gate clock signals GCK1-GCK4 restart to toggle.

Subsequently, during the 21^{st} to the 32^{nd} horizontal line periods corresponding to the 21^{st} to the 32^{nd} scan lines in the partial refresh display area A3, the gate clock signals GCK1-GCK4 stop toggling again. At this time, the corresponding output enable circuits OE6-OE8 stop outputting the scan driving signals GL21-GL32 in response to the stopped toggling of the gate clock signals GCK1-GCK4, to stop the refresh in the partial refresh display area A3.

As can be seen, under the normal output of the frame start pulse STV and the shift clock CK SR, the full refresh display area(s) and the partial refresh display area(s) may be allocated in any manner by controlling the gate clock signals to toggle in the full refresh display area(s) and stop toggling in the partial refresh display area(s). For example, if a display panel is used to play a video in a middle area with some texts above and below the video area, it is possible to set the video area as the full refresh display area to perform data refresh in all frame periods, and set the text areas as the partial refresh display area to perform data refresh in fewer frame periods.

In the partial refresh display area, since the pixels are not turned on by the corresponding scan driving signals, pixel data displayed by these pixels would not be refreshed. In order to increase the power saving effect, the source driver 118 of the display driver circuit 110 may stop outputting the data voltages VD to the display panel 100 in response to the stopped toggling of the gate clock signals GCK1-GCK4 when the scan operation proceeds to the partial refresh display area. In various embodiments, the display driver circuit 110 may stop outputting the data voltages VD by controlling the source driving channels to be floating or at a specific voltage (e.g., ground voltage).

Note that the display driver circuit 110 stopping outputting the data voltages VD in the partial refresh display area is merely an exemplary embodiment. In another embodiment, the display driver circuit 110 may still normally output the data voltages VD in the partial refresh display area where the pixels are not refreshed. As long as the corresponding scan driving signals are not output to the pixels, the refresh operations of these pixels may be stopped regardless of whether the data voltages VD are received.

In addition, if the display panel is implemented with a MUX circuit such as the MUX circuit 502 shown in FIG. 5, the display driver circuit 110 may also stop outputting (e.g., stop toggling) the switching signals SW to the MUX circuit 502 in response to the stopped toggling of the gate clock signals GCK1-GCK4 when the scan operation proceeds to the partial refresh display area. The stopped toggling of the switching signals SW may further reduce the power consumption.

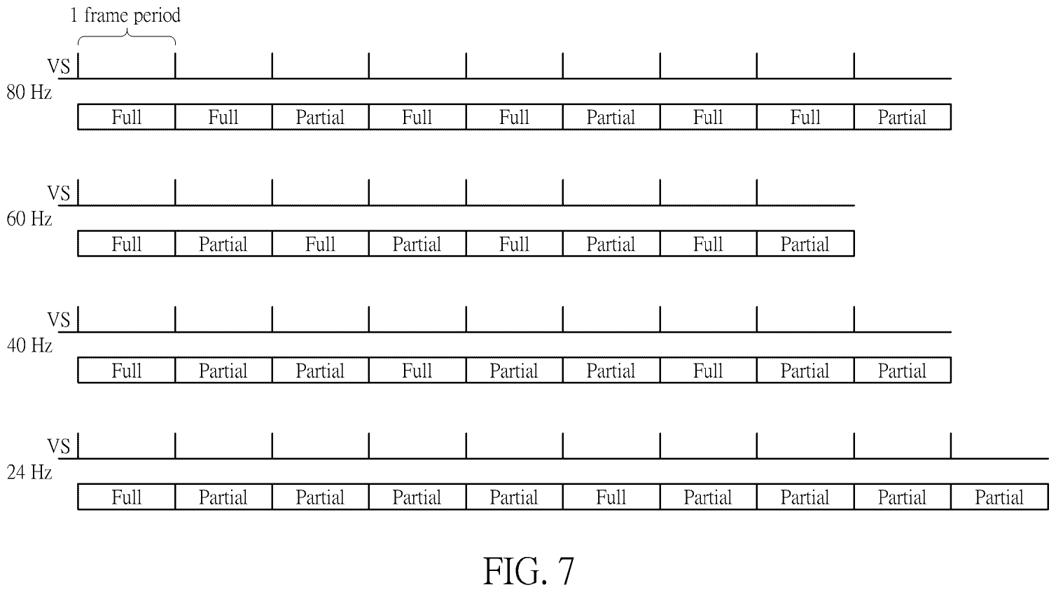

Note that different frame rates may be realized in the display system by allocating the full refresh display area and the partial refresh display area on the display panel. Therefore, a series of frame periods may be arranged to the full refresh frame period or the partial refresh frame period in any manner to realize different frame rates. For example, as shown in FIG. 7, assuming that the basic frame rate of a display panel is 120 Hz, the image frames may be arranged to have 2 full refresh frame periods and 1 partial refresh frame periods output alternately, and thus the overall frame rate will be equal to 80 Hz. In another embodiment, the image frames may be arranged to have 1 full refresh frame period and 1 partial refresh frame period output alternately, and thus the overall frame rate will be equal to 60 Hz. In another embodiment, the image frames may be arranged to have 1 full refresh frame period and 2 partial refresh frame periods output alternately, and thus the overall frame rate will be equal to 40 Hz. In another embodiment, the image frames may be arranged to have 1 full refresh frame period and 4 partial refresh frame periods output alternately, and thus the overall frame rate will be equal to 24 Hz.

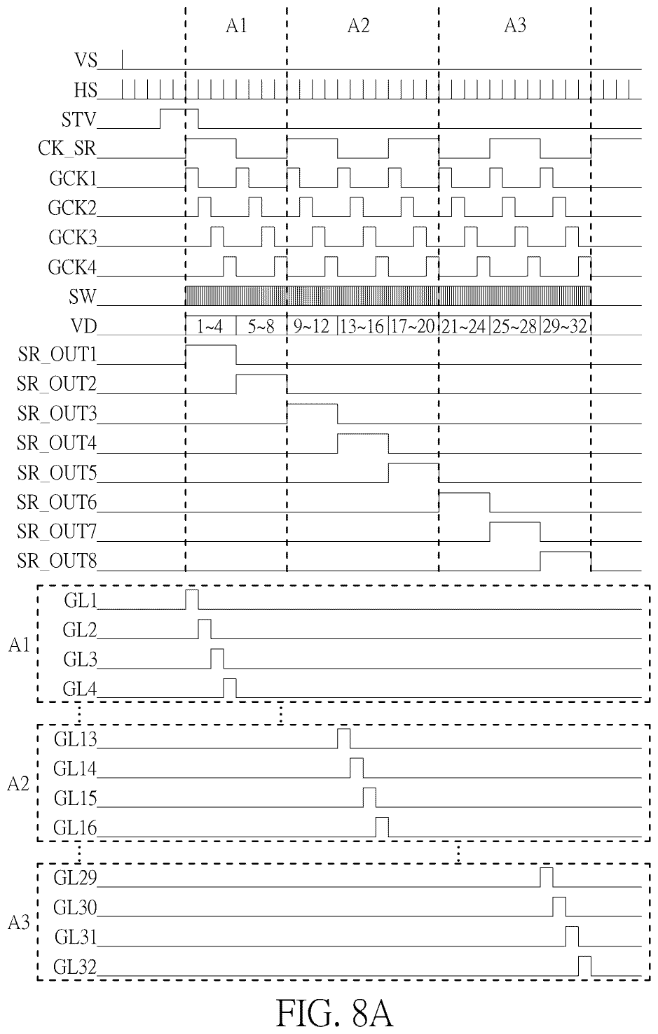

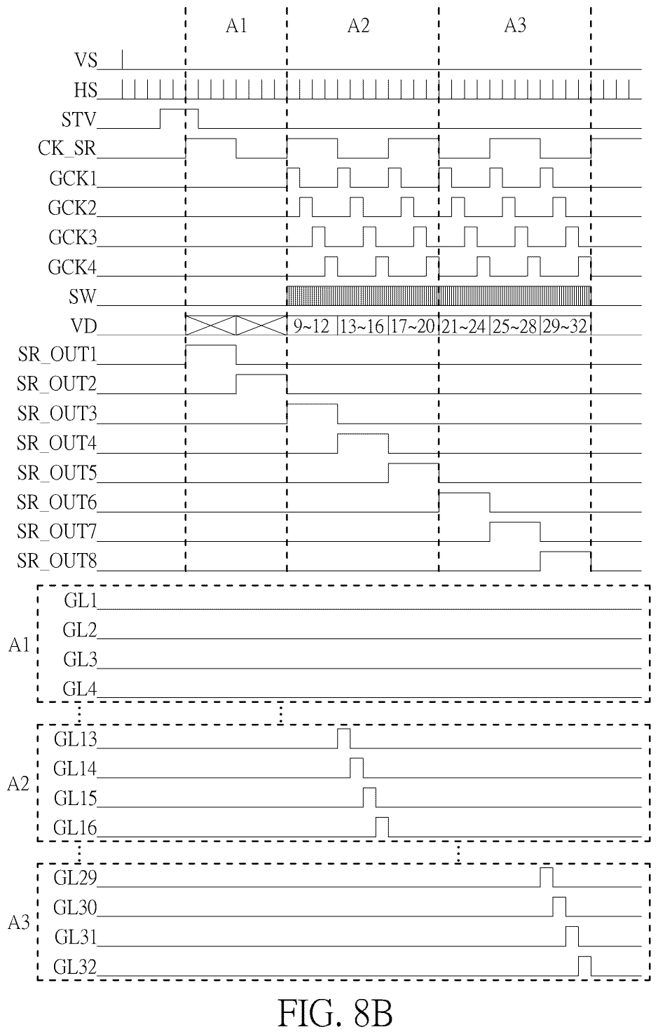

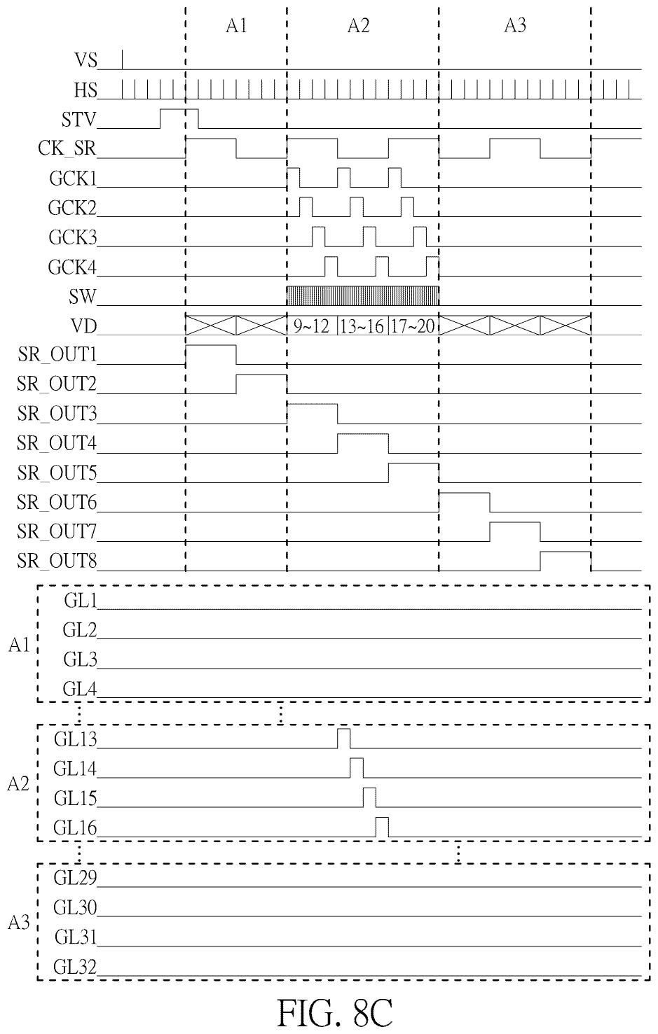

In another embodiment, the frame periods may be further combined to realize more than 2 different frame rates. For example, FIGS. 8A-8C illustrate an exemplary implementation of realizing more different frame rates in different areas of the display panel 100, where FIG. 8A shows the signals in a full refresh frame period, and FIGS. 8B and 8C show the signals in partial refresh frame periods having different behaviors. In this embodiment, the display panel 100 is divided into 3 areas A1-A3, where the areas A1 and A3 are partial refresh display areas configured with different refresh rates, and the area A2 is a full refresh display area.

As shown in FIG. 8A, in the full refresh frame period, the gate clock signals GCK1-GCK4 are output in the areas A1-A3, and thus pixel data displayed by the pixels in the areas A1-A3 are all refreshed. The data voltages VD and the corresponding switching signals SW are also output normally to perform refresh.

As shown in FIG. 8B, in this partial refresh frame period, the gate clock signals GCK1-GCK4 stop toggling in the area A1 while toggle normally in the areas A2 and A3, and thus pixel data displayed by the pixels in the areas A1 are not refreshed and pixel data displayed by the pixels in the areas A2 and A3 are refreshed. In such a situation, the display driver circuit 110 may stop outputting the data voltages VD and the corresponding switching signals SW when the scan operation proceeds to the area A1.

As shown in FIG. 8C, in this partial refresh frame period, the gate clock signals GCK1-GCK4 stop toggling in the areas A1 and A3 while toggle normally in the area A2, and thus pixel data displayed by the pixels in the areas A1 and A3 are not refreshed and pixel data displayed by the pixels in the area A2 are refreshed. In such a situation, the display driver circuit 110 may stop outputting the data voltages VD and the corresponding switching signals SW when the scan operation proceeds to the areas A1 and A3.

The display panel 100 may be refreshed by arranging a series of frame periods to have a timing sequence by combining the refresh behaviors shown in FIGS. 8A-8C in any manner, to realize different refresh rates in the areas A1-A3. For example, assuming that the basic frame rate of the display panel is 120 Hz, an implementation may realize a refresh rate 40 Hz in the area A1, a refresh rate 120 Hz in the area A2, and a refresh rate 80 Hz in the area A3. Note that the frame rate and the refresh rate both refer to the refresh number of times per second in a display area, and these two terms could be equivalent and are used interchangeably in this disclosure.

As can be seen, the frame rates of the MFD may be arranged in any possible manner by combining the full refresh frame period(s) and the partial refresh frame period(s) having different refresh behaviors, and the combination methods should not be limited to those described in this disclosure.

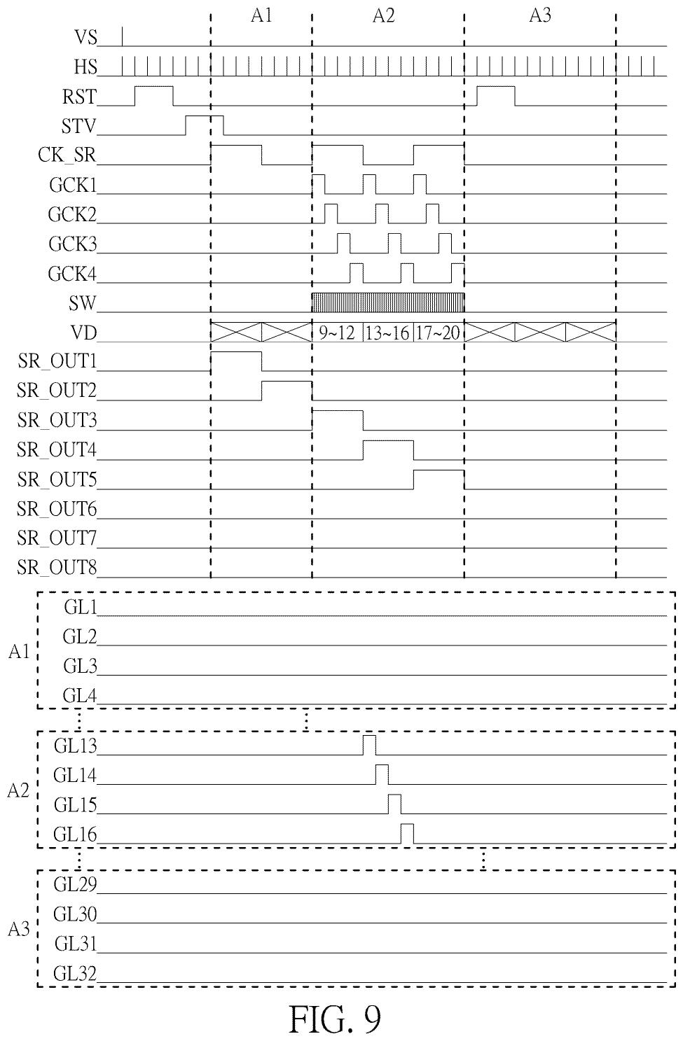

In one or several embodiments, the display driver circuit 110 is configured to output a reset signal RST to the GOA circuit 104. For example, as shown in FIG. 1, the reset signal RST may be sent to the GOA circuit 104, and may be used to reset the operations of the SR circuits SR1-SR8. FIG. 9 is a timing diagram of the GOA circuit 104 in a partial refresh frame period with the reset signal RST. As shown in FIG. 9, the reset signal RST includes a first pulse before the frame start pulse STV and a second pulse after the gate clock signals GCK1-GCK4 stop toggling. The first pulse may reset the SR circuits SR1-SR8 before the SR circuits SR1-SR8 start to generate the shift control signals SR_OUT1-SR_OUT8 in response to the reception of the frame start pulse STV. The second pulse may control the SR circuits SR1-SR8 to stop outputting the shift control signals. In this embodiment, the second pulse is output after the end of the area A2 where the shift control signal SR_OUT5 has been output. Therefore, the subsequent shift control signals SR_OUT6-SR_OUT8 are stopped by using the pulse of the reset signal RST. The stopped shift control signals SR_OUT6-SR_OUT8 and the stopped operations of the corresponding SR circuits SR6-SR8 may further reduce the power consumption of the GOA circuit 104. In an alternative embodiment, the reset signal RST may only include the first pulse to reset the SR circuits SR1-SR8 before they start to generate the shift control signals SR_OUT1-SR_OUT8, and the second pulse after the end of the full refresh display area may be omitted without affecting the scan driving outputs.

Note that the present invention aims at providing a novel method of driving a display panel to realize the MFD control. Those skilled in the art may make modifications and alterations accordingly. For example, in the above embodiments, the display driver circuit 110 is configured to output 4 gate clock signals GCK1-GCK4 to the output enable circuits OE1-OE8 in the GOA circuit 104. In another embodiment, there may be any number of gate clock signals to be sent to the GOA circuit. For example, the shift clock may be set to allow a shift control signal to shift to the next SR circuit in 8 horizontal line periods, and thus each output enable circuit is configured to sequentially output 8 scan driving signals to control 8 pixel rows in the 8 horizontal line periods. In such a situation, each output enable circuit may receive 8 gate clock signals to enable or disable the corresponding 8 scan driving signals, depending on whether the corresponding pixel row is allocated to the full refresh display area or the partial refresh display area.

In addition, the method of the present invention is applicable to any type of display panel such as an LCD panel, but not limited thereto. In the LCD panel, the GOA circuit is configured to provide a scan driving signal to each pixel row, where the scan driving signal may be fed to the gate terminal of the driving transistor in each pixel. In another embodiment, the GOA circuit of the present invention is also applicable to an organic light emitting diode (OLED) panel or the like, where the scan driving signal of the GOA circuit may be used for gate control or emission control.

To sum up, the present invention provides a method of driving a display panel, a display driver circuit used for driving the display panel, and a GOA circuit of the display panel, to achieve an MFD application where the images in different areas of the display panel are displayed with different frame rates. The display driver circuit may output the frame start pulse and the shift clock to the GOA circuit normally, to control the SR circuits in the GOA circuit to generate and output the shift control signals sequentially. The display driver circuit thereby outputs the gate clock signals based on the allocations of the full/partial refresh display areas. In various embodiments, the gate clock signals may stop toggling when the scan operation proceeds to the partial refresh display area, and may keep toggling when the scan operation proceeds to the full refresh display area. Through the control of the gate clock signals, the output enable circuits in the GOA circuit may output the scan driving signals to the pixel rows in the full refresh display area, while stopping outputting the scan driving signals to the pixel rows in the partial refresh display area. In such a situation, based on the image content, each pixel row may receive the scan driving signal or not in each frame period through the control of the gate clock signals, to be refreshed or not accordingly. In addition, each frame period may be arranged as a full refresh frame period or a partial refresh frame period, where all areas of the display panel are refreshed in the full refresh frame period, while only one or some areas of the display panel are refreshed in the partial refresh frame period. Through appropriate combination of the full/partial refresh display areas and appropriate combination of the full/partial refresh frame periods, various refresh rates may be realized in each area of the display panel, to realize flexible MFD control.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of driving a display panel, the display panel comprising a full refresh display area and a partial refresh display area, the method comprising:
outputting a plurality of gate clock signals to the display panel, the plurality of gate clock signals being used by a gate driving circuit in the display panel, to generate a plurality of scan driving signals;
wherein in a partial refresh frame period, the plurality of gate clock signals keep toggling during N horizontal line periods corresponding to the full refresh display area and stop toggling during M horizontal line periods corresponding to the partial refresh display area.

2. The method of claim 1, wherein the plurality of gate clock signals keep toggling during a full refresh frame period, including N horizontal line periods corresponding to the full refresh display area and M horizontal line periods corresponding to the partial refresh display area.

3. The method of claim 1, further comprising:
outputting a shift clock to a plurality of shift register circuits of the gate driving circuit, the plurality of shift register circuits being configured to generate a plurality of shift control signals according to the shift clock, wherein the plurality of shift control signals are used for sequentially outputting the plurality of scan driving signals.

4. The method of claim 3, wherein the plurality of shift register circuits output the plurality of shift control signals in the M horizontal line periods corresponding to the partial refresh display area.

5. The method of claim 1, further comprising:
outputting a reset signal to a plurality of shift register circuits of the gate driving circuit, wherein in the partial refresh frame period, the reset signal comprises a first pulse before a frame start pulse and a second pulse after the plurality of gate clock signals stop toggling.

6. The method of claim 1, further comprising:
stopping outputting display data to the display panel in response to the plurality of gate clock signals stopping toggling.

7. The method of claim 1, further comprising:
stopping outputting a plurality of switching signals to the display panel in response to the plurality of gate clock signals stopping toggling, wherein each of the plurality of switching signals is used to electrically connect one of a plurality of source driving channels of a display driver circuit and one of a plurality of data lines of the display panel.

8. A display driver circuit for driving a display panel, the display panel comprising a full refresh display area and a partial refresh display area, the display driver circuit comprising:
a timing control circuit, configured to output a plurality of gate clock signals to the display panel, the plurality of gate clock signals being used by a gate driving circuit in the display panel, to generate a plurality of scan driving signals;
wherein in a partial refresh frame period, the plurality of gate clock signals keep toggling during N horizontal line periods corresponding to the full refresh display area and stop toggling during M horizontal line periods corresponding to the partial refresh display area.

9. The display driver circuit of claim 8, wherein the plurality of gate clock signals keep toggling during a full refresh frame period, including N horizontal line periods corresponding to the full refresh display area and M horizontal line periods corresponding to the partial refresh display area.

10. The display driver circuit of claim 8, wherein the timing control circuit is further configured to output a shift clock to a plurality of shift register circuits of the gate driving circuit, and the plurality of shift register circuits are configured to generate a plurality of shift control signals according to the shift clock, wherein the plurality of shift control signals are used for sequentially outputting the plurality of scan driving signals.

11. The display driver circuit of claim 10, wherein the plurality of shift register circuits output the plurality of shift control signals in the M horizontal line periods corresponding to the partial refresh display area.

12. The display driver circuit of claim 8, wherein the timing control circuit is further configured to output a reset signal to a plurality of shift register circuits of the gate driving circuit, wherein in the partial refresh frame period, the reset signal comprises a first pulse before a frame start pulse and a second pulse after the plurality of gate clock signals stop toggling.

13. The display driver circuit of claim 8, further comprising:
a plurality of source driving channels, configured to stop outputting display data to the display panel in response to the plurality of gate clock signals stopping toggling.

14. The display driver circuit of claim 8, wherein the timing control circuit is further configured to stop outputting a plurality of switching signals to the display panel in response to the plurality of gate clock signals stopping toggling, wherein each of the plurality of switching signals is used to electrically connect one of a plurality of source driving channels of the display driver circuit and one of a plurality of data lines of the display panel.

15. A gate driving circuit of a display panel, the display panel comprising a full refresh display area and a partial refresh display area, the gate driving circuit comprising:
a plurality of shift register circuits, comprising a first shift register circuit and a second shift register circuit, wherein the first shift register circuit is configured to generate a first shift control signal which is utilized for generating a plurality of first scan driving signals driving scan lines in the full refresh display area, and the second shift register circuit is configured to generate a second shift control signal which is utilized for generating a plurality of second scan driving signals driving other scan lines in the partial refresh display area; and
a plurality of output enable circuits, comprising a first output enable circuit and a second output enable circuit, wherein the first output enable circuit is configured to generate the plurality of first scan driving signals according to the first shift control signal and a plurality of gate clock signals, and the second output enable circuit is configured to generate the plurality of second scan driving signals according to the second shift control signal and the plurality of gate clock signals;
wherein the second output enable circuit stops outputting the plurality of second scan driving signals in response to the plurality of gate clock signals stopping toggling.

16. The gate driving circuit of claim 15, wherein the first output enable circuit outputs the plurality of first scan driving signals in response to the plurality of gate clock signals keeping toggling.

17. The gate driving circuit of claim 15, wherein the plurality of gate clock signals keep toggling during N horizontal line periods corresponding to the full refresh display area and stop toggling during M horizontal line periods corresponding to the partial refresh display area.

18. The gate driving circuit of claim 15, wherein each of the plurality of output enable circuits comprises a plurality of logic gates, each logic gate for performing a logic operation on a received shift control signal and a gate clock signal among the plurality of gate clock signals to generate a scan driving signal.

19. The gate driving circuit of claim 15, wherein the plurality of shift register circuits are further configured to receive a reset signal, to stop outputting the plurality of shift control signals in the partial refresh display area.
